(19) United States
(12) Patent Application Publication
(10) Pub. No.: US 2004/0135826 A1
(43) Pub. Date: Jul. 15, 2004

(54) Method for defining a range of objects

(76) Inventor: Craig Pickering, Alpharetta, GA (US)

Correspondence Address: Gregory S. Smith, P.O. Box 88148, Atlanta, GA, 30356, US

(21) Appl. No.: 10/341,650

(22) Filed: Jan. 14, 2003

(51) Int. Cl. G09G 5/00

(52) U.S. Cl. 345/860; 345/857

(57) ABSTRACT

An improved method for defining a range of objects is described, illustrated and claimed. The novel system and method allows for quick and efficient definition of all or a portion of a plurality of objects and, optionally, applies a rule thereto. A first and a second slideable selector are positioned relative to at least one object in a plurality of objects. A range is defined relative to the objects located within and including the objects relative to said first and second slideable selectors. A rule may then be applied to the range of objects defined by said first and second slideable selectors.

### TECHNICAL FIELD

The present invention relates to control interfaces for computer programs and, more particularly to an improved method of defining a range of objects and, optionally, performing a rule thereto, displayed by a computer program, in response to simple actions performed by a user or process.

### BACKGROUND OF THE INVENTION

Computer users have become accustomed to using computer software applications that present information through a graphical user interface. A number of methods for presenting information have become de facto standards. For instance, checkboxes, pushbuttons, radio buttons, scroll bars, sliders, and track bars are used throughout the industry. These items are referred to as graphical user interface objects, or graphical objects. Users typically interact with software applications having a graphical user interface by moving a pointing cursor over a graphical object using, for example, a mouse or similar pointing device such as a light pen, and then indicating (for example, by clicking a mouse button or pressing the light pen) that the object should be selected. Alternatively, some graphical user interfaces may be presented on a touch-sensitive display screen. In that situation, the user interacts with the software application by touching the graphical object he wishes to select.

The programmer writing a software application having a graphical user interface defines the physical layout of the graphical objects on the user interface screen, as well as the function, if any, to be associated with the objects and any logical relationships among those objects. The function represented by a graphical object can be as simple as setting the value of a variable used by a software application, or it can represent a more complex function such as initiating the execution of a software subroutine, or any other function desired by the programmer.

One common function of a graphical object is the task of selecting items or objects within a computer program. Typically, a user may wish to select one object, multiple objects or even every object in a particular program. Many different types of graphical user interface objects with a combination of many different functions can be used to perform this task. For example, a “select all” checkbox could be used to select all of a particular object. In addition to using graphical objects to select objects, a combination of keystrokes can be used, such as, depressing the “shift” key in combination with toggling the arrow key to select the objects, however, the keystrokes are prone to typographical errors, are slower and more tedious to perform than using a graphical object. In addition, after the selections have been made, there is no good way to error check the selections. Therefore, using a graphical object is easier, more reliable and quicker.

When a user wishes to define a range of objects, however, there are currently no graphical objects to perform the task effectively. Typically, defining a range of objects is performed by moving a pointing cursor over a first object using a mouse and clicking the mouse button to select a first object and then, performing an action, such as holding down the shift key and moving the pointing cursor to a second object and selecting the second object. Thus, a range of objects between and including the first and second selected objects will be defined. Further, to define a new range, the entire process must be repeated, even if the new range has a common first or second object. In addition, once a range is defined, a user typically applies a rule to the range. Some common rules include: select, delete, copy, highlight, etc., however, text editing rules or text insertion rules cannot be applied to the entire range. These rules cannot be applied because the structure of the range still categorizes the individual objects within the range separately.

What is needed, therefore, is a method for quickly and efficiently defining a range of objects that overcomes the aforementioned problems and also incorporates the ability to apply text editing and text insertion rules to the entire range.

### SUMMARY OF THE INVENTION

In general, the present invention can be described as a novel system and method for quickly and efficiently defining a range of all or a portion of a plurality of objects using a graphical user interface object and, optionally, applying a rule thereto. More specifically, positioning a first slider relative to one of the plurality of objects by performing an operation (i.e. single or double clicking on an object using a mouse, selecting the first slider and dragging it with the mouse, pressing the object on a touch-sensitive screen, etc.) and positioning a second slider relative to one of the plurality of objects by performing a similar operation, wherein a range of all or a portion of the plurality of objects located between the first and second slider (inclusive or exclusive) is defined such that a rule may be applied. The range may include the objects relative to the first and second slider as well as the objects between the first and second slider. Alternatively, the range may be defined by the objects outside of the slideable selectors. Further, the face of the object for each of the plurality of objects in the range may then be modified to reflect inclusion into the range, for instance the face may then be shown as highlighted, to indicate this status. A rule may then be performed upon the range of objects defined by the first and second sliders. The rule may include any of a variety of rules, such as, select or deselect the objects, toggle or change the state or status of an object, update or refresh the object, delete or copy the object, change the attributes of the object, associate an input with the object, edit the text of an object, or the like. For example, using the “associate an input” rule, an input is entered and the contents of each object within the range dictated by the sliders will change to the input once the rule is performed on the object. Additionally, the face of the contents of each object within the range may be modified to reflect the performance of the rule, for instance the face may then be shown as highlighted, to indicate this status. At that point, if the user wishes, he can enter a new input to change the value of each object within the range dictated by the sliders, or he can select a new range, in the same manner as before, to perform a new rule upon.

An object of the present invention is to provide a method and technique for quickly and efficiently performing rules on a range of all or a portion of a plurality of objects, wherein the range is easily checked for errors.

Another object of the present invention is to provide a method and technique for quickly and efficiently performing rules on a range of all or a portion of a plurality of objects, with simple articulation.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a system diagram that illustrates an exemplary environment suitable for implementing various embodiments of the present invention.

FIG. 2 is a view of a computer screen, depicting typical graphical user interface objects through a window.

FIGS. 3A-B are flow diagrams illustrating the method of an exemplary embodiment of the present invention as perceived by a computing device.

FIGS. 4A-C illustrate an exemplary embodiment of the present invention depicted on a graphical user interface display of a computer workstation.

FIGS. 5A-C illustrate another exemplary embodiment of the present invention depicted on a graphical user interface display of a computer workstation.

### DETAILED DESCRIPTION

In general, the present invention can be described as a novel system and method for quickly and efficiently performing rules on a range of all or a portion of a plurality of objects. Some examples of objects include, but are not limited to: physically and logically grouped objects, ungrouped objects, graphical objects, graphical user interface objects, textual objects, etc. As with the exemplary embodiments below, these examples are for illustrative purposes only and, a person skilled in the art will construe them broadly.

Referring now to the figures, in which like numerals refer to like elements throughout the several views, exemplary embodiments of the present invention are described. Throughout the detailed description, reference will be made to the operation of the present invention when embodied within a computing device. Computing devices may include, but are not limited to, personal computers, mainframe computers, servers, and any other device capable of executing the software associated with the present invention. It should be understood that the features and aspects of the present invention can be ported into a variety of systems and system/network configurations and any examples provided within this description are for illustrative purposes only.

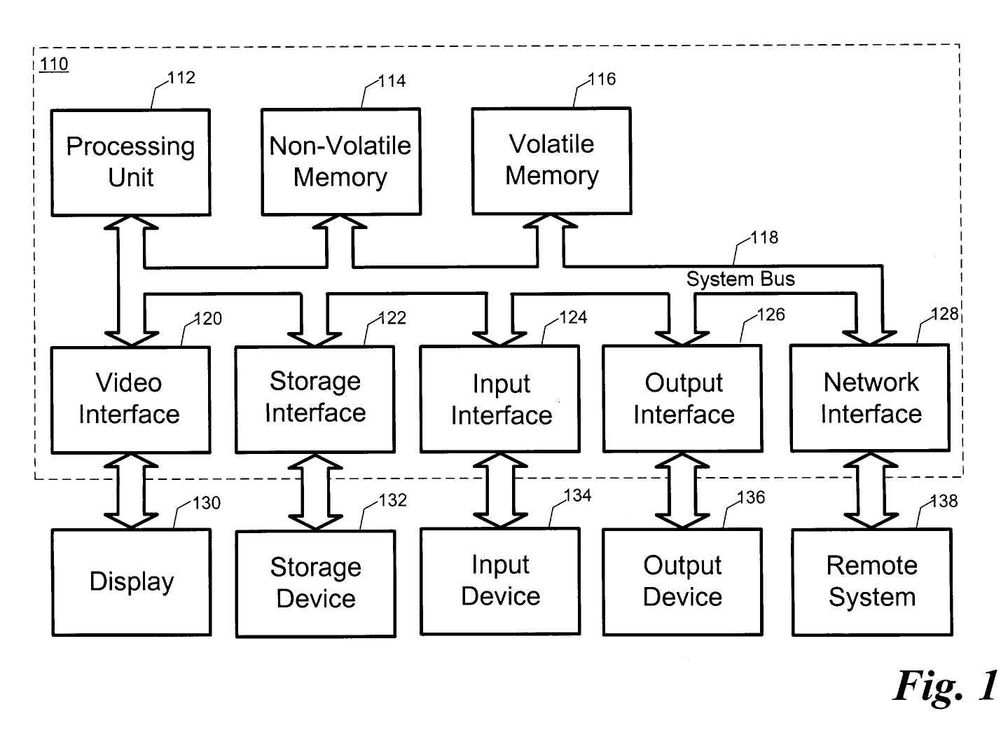

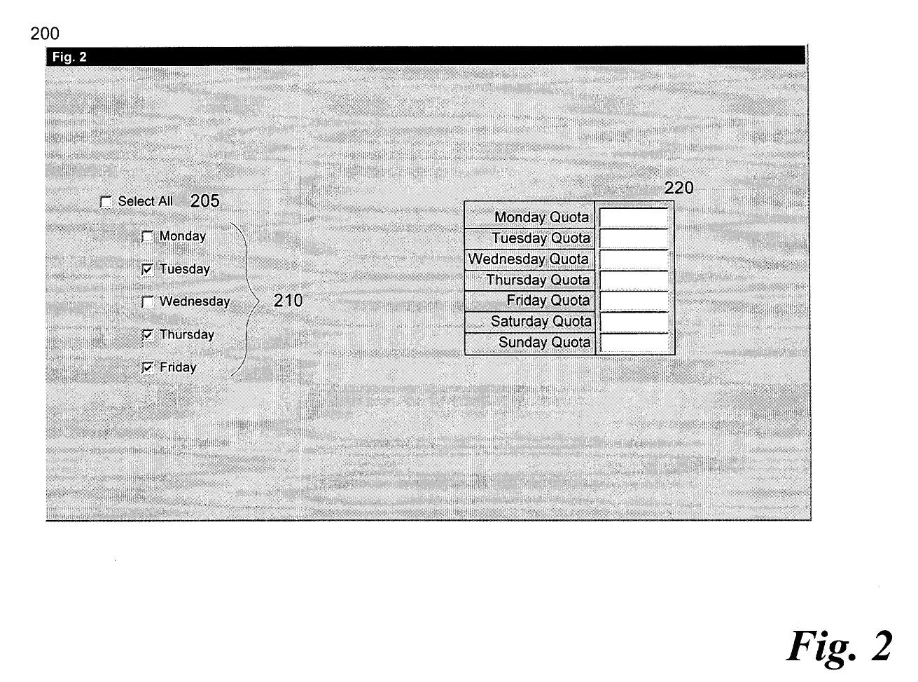

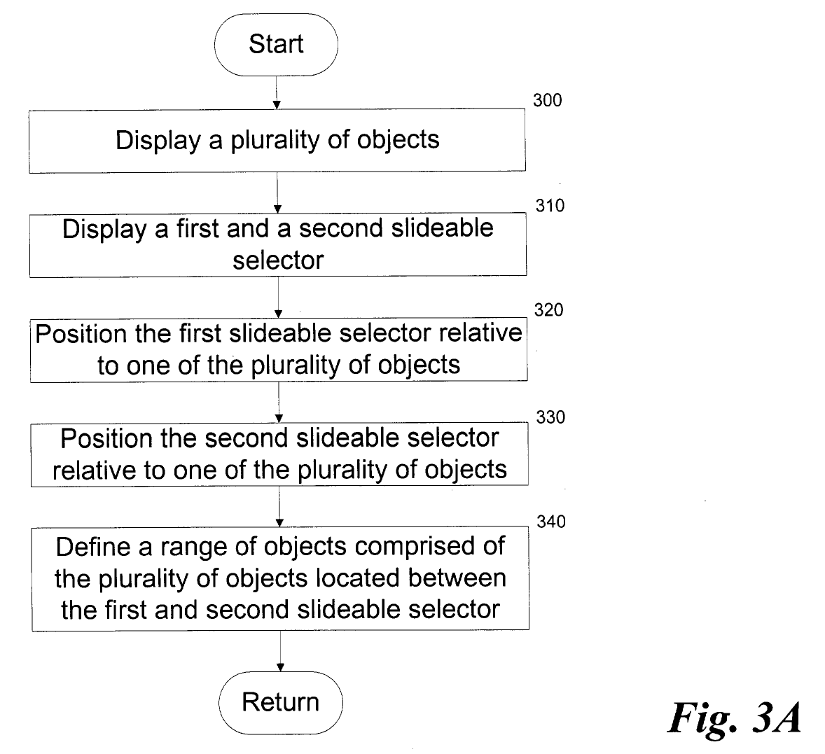

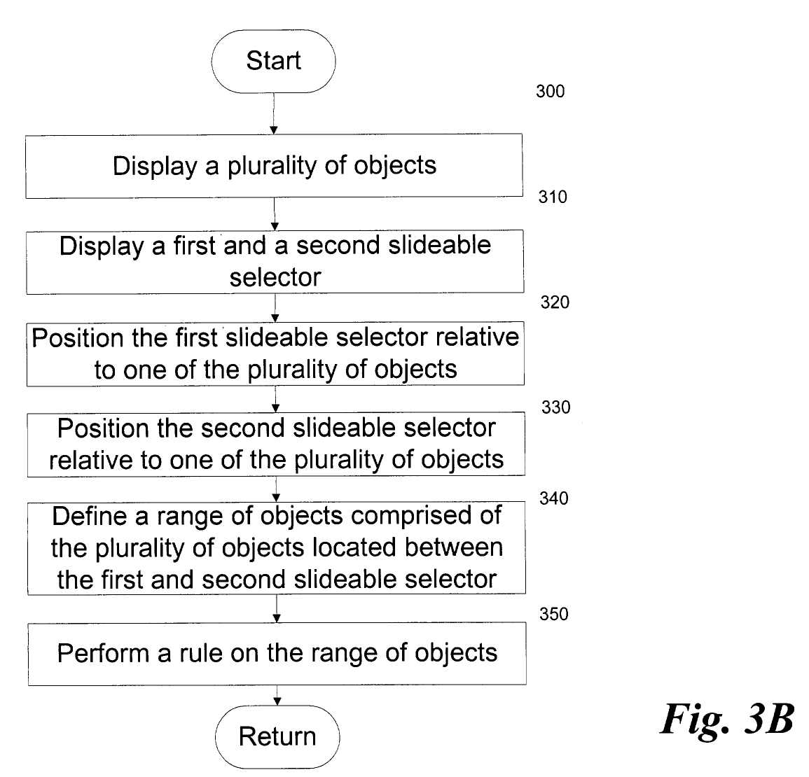

In conjunction with FIG. 1, the components of a general platform on to which aspects of the present invention can be implemented are described. Next, the components of a general application onto which aspects of the present invention are described in conjunction with FIG. 2. Finally, various operations of exemplary embodiments of the present invention are described in conjunction with FIGS. 3-5.

Exemplary Environment

FIG. 1 is a system diagram that illustrates an exemplary environment suitable for implementing various embodiments of the present invention. FIG. 1 and the following discussion provide a general overview of a platform onto which the invention, or portions thereof, may be integrated, implemented and/or executed. Although in the context of the exemplary environment the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 1 may take on many forms and may be directed towards performing a variety of functions. Generally, the system illustrated in FIG. 1 may be any system that includes a computer processor. Examples of such forms and functions include, but are not limited to, personal computers, hand-held devices such a personal data assistants, note-book computers, lap-top computers, mainframe computers, servers and a variety of other applications, each of which may serve as an exemplary environment for embodiments of the present invention.

The exemplary system illustrated in FIG. 1 includes a computing device 110 that is made up of various components including, but not limited to a processing unit 112, non-volatile memory 114, volatile memory 116, and a system bus 118 that couples the non-volatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 114 provides storage for power on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic random access memory (DRAM), FLASH memory, EEPROM, bubble memory, registers, or the like. The volatile memory 116 provides temporary storage for routines, modules, functions, macros, data, etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain in tact, whereas the contents of the volatile memory 116 are lost, corrupted, or erased.

The computing device 110 may access one or more external display devices 130 such as a CRT monitor, LCD panel, LED panel, electro-luminescent panel, or other display device, for the purpose of providing information or computing results to a user. In some embodiments, the external display device 130 may actually be incorporated into the product itself. The processing unit 112 interfaces to each display device 130 through a video interface 120 coupled to the processing unit 110 over the system bus 118.

The computing device 110 may interface with one or more storage devices such as a hard disk drive, a compact disk drive, a floppy disk drive, a RAM drive or other memory drive, for the purpose of storing information, program data or programs. The storage device 132 is accessed through a storage interface 122 that connects to the system bus 118.

The computing device 110 may send output information, in addition to the display 130, to one or more output devices 136 such as a speaker, modem, printer, plotter, facsimile machine, RF or infrared transmitter, computer or any other of a variety of devices that can be controlled by the computing device 110. The processing unit 112 interfaces to each output device 136 through an output interface 126 coupled to the processing unit 112 over the system bus 118. The output interface 126 may include one or more of a variety of interfaces, including but not limited to, cable modems, DLS, T1, V series modems, an RS-232 serial port interface or other serial port interface, a parallel port interface, a universal serial bus (USB), a general purpose interface bus (GPIB), an optical interface such as infrared or IRDA, an RF or wireless interface such as Bluetooth, or other interface.

The computing device 110 may receive input or commands from one or more input devices 134 such as a keyboard, pointing device, mouse, modem, RF or infrared receiver, microphone, joystick, track ball, light pen, game pad, scanner, camera, computer or the like. The processing unit 112 interfaces to each input device 134 through an input interface 124 coupled to the processing unit 112 over the system bus 118. The input interface 124 may include one or more of a variety of interfaces, including but not limited to, cable modems, DSL, T1, V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

It will be appreciated that program modules implementing various embodiments of the present invention may be stored in the non-volatile memory 114, the volatile memory 116, or in a remote memory storage device accessible through the output interface 126 and the input interface 124. The program modules may include an operating system, application programs, other program modules and program data. The processing unit 112 may access various portions of the program modules in response to the various instructions contained therein, as well as under the direction of events occurring or being received over the input interface 124.

The computing device 110 may interface with one or more remote systems 138, such as a server or client, through a network interface 128. In a networked configuration, some or all of the components of the present invention may be distributed and operate on one or more remote systems 138. The present invention may be embodied in a web application that is assessable on a remote system 138 through a browser type application running on processing unit 112.

Components of a Typical Screen

FIG. 2 is a “screen shot” 200 that illustrates typical selectable objects in a window. The selectable objects are shown both with a graphical user interface and with associated text fields. Generally, the screen shot illustrated in FIG. 2 may be any screen that includes selectable objects. Examples of such forms and functions that a screen may be displayed on include, but are not limited to, personal computers, hand-held devices such a personal data assistants, note-book computers, lap-top computers, mainframe computers, servers and a variety of other applications, each of which may serve as an exemplary environment for embodiments of the present invention.

More particularly, the screen shot 200 in FIG. 2 includes a plurality of selectable objects 205, 210 and 220. The selectable objects 205 and 210 are associated with graphical user interface objects, in this example checkboxes. When the checkboxes are selected, the associated object is selected. Further, object 205 is associated with a “select all” checkbox that is linked with objects 210. When object 205 is selected, all of the objects 210 are also selected. The selectable objects 220 are associated with an input area or textbox. When any of objects 220 are selected their corresponding textbox is also selected.

Operations of Exemplary Embodiments

The exemplary embodiments of the present invention will now be discussed with reference to FIGS. 3-5.

In general, the present invention can be described as a novel system and method for quickly and efficiently defining a range of all or a portion of a plurality of objects and applying a rule thereto. For illustrative purposes, the present invention will be described using a logically-defined group of graphical user interface objects, these examples are for illustrative purposes only and, a person skilled in the art will construe them broadly.

The present invention illustrates a software application that presents graphical objects representing multiple choice selections, which selections have been physically and/or logically grouped by a programmer writing the software application. The graphical object used for the multiple choice selection items may be a textbox, or it may be some other type of graphical object used to represent the function described herein as being associated with a textbox. For ease of description, this object is referred to hereinafter as a textbox.

One aspect of the present invention allows for quick and efficient definition of a range of members of the logically-defined group of graphical user interface objects, by performing an operation (i.e. single or double clicking on an object using a mouse, selecting a slider and dragging it with the mouse, pressing the object on a touch-sensitive screen, etc.). As an example, a user may define a range in a group of a plurality of textboxes by positioning a first slider relative to one of the group by clicking on the first slider and dragging it with a mouse to a desired location and, then, positioning a second slider relative to one of the group in a similar manner; wherein the plurality of textboxes between the first and second sliders define the range. The range may include the textboxes relative to the first and second slider as well as the textboxes between the first and second slider. In this example, if a range of the group had a status of “included” before the user performs the operation on the objects, the status of the range “outside” of a newly selected range would change to “not included,” and only the textboxes “inside” of the newly selected range would retain the status of “included.” The face of each textbox within the range may then be modified to reflect the inclusion into the range (i.e. highlighted, etc.).

Another aspect of the present invention is the application of a rule onto the range of textboxes. Once a range is defined with a first and second slider, a rule can be applied to the entire range. The rule can include any of a variety of rules, such as, select or deselect the objects, toggle or change the state or status of an object, update or refresh the object, delete or copy the object, change the attributes of the object, associate an input with the object, or the like. As an example, a user may apply the “associate an input” rule to a range of textboxes. An input area is defined and an input is entered that is associated with the range of textboxes. The contents of each textbox within the range dictated by the sliders will change to the input once the rule is performed on the textbox. Additionally, the face of the contents of each textbox within the range may be modified to reflect the performance of the rule, for instance the face may then be shown as bolded, to indicate this status. At that point, if the user wishes, he can enter a new input to change the value of each textbox within the range dictated by the sliders, or he can select a new range, in the same manner as before, to perform a new rule upon.

FIGS. 3A-3B illustrate the logical steps performed by a computer application embodying the present invention. It will be obvious to one skilled in the art how to incorporate the processes of FIGS. 3A-3B into a larger process for handling general interactions with a graphical user interface.

FIG. 3A illustrates an exemplary embodiment of the present invention; the process begins with the computer displaying a plurality of objects at Step 300. Next, the computer displays a first and a second slideable selector at Step 310. The first and second slideable selectors are associated with the plurality of objects. Next, based upon a users operation, the computer positions the first slideable selector relative to one of the plurality of objects at Step 320. Based upon a users operation, the computer positions the second slideable selector relative to one of the plurality of objects at Step 330. Finally, a range is defined by all or a portion of the objects located between the first and second slideable selectors at Step 340. The range may include the objects relative to the first and second slider as well as the objects between the first and second slider.

FIG. 3B illustrates an exemplary embodiment of the present invention; the process begins with the computer displaying a plurality of objects at Step 300. Next, the computer displays a first and a second slideable selector at Step 310. The first and second slideable selectors are associated with the plurality of objects. Next, based upon a users operation, the computer positions the first slideable selector relative to one of the plurality of objects at Step 320. Based upon a users operation, the computer positions the second slideable selector relative to one of the plurality of objects at Step 330. A range is then defined by all or a portion of the objects located between the first and second slideable selectors at Step 340. The range may include the objects relative to the first and second slider as well as the objects between the first and second slider. Finally, a rule is performed on the range of objects defined by the first and second slideable selectors at Step 350.

The flexibility of the present invention allows for the versatility of utilizing multiple rules. Thus, the speed and efficiency of applying certain rules to groups of objects can be customized depending on the application.

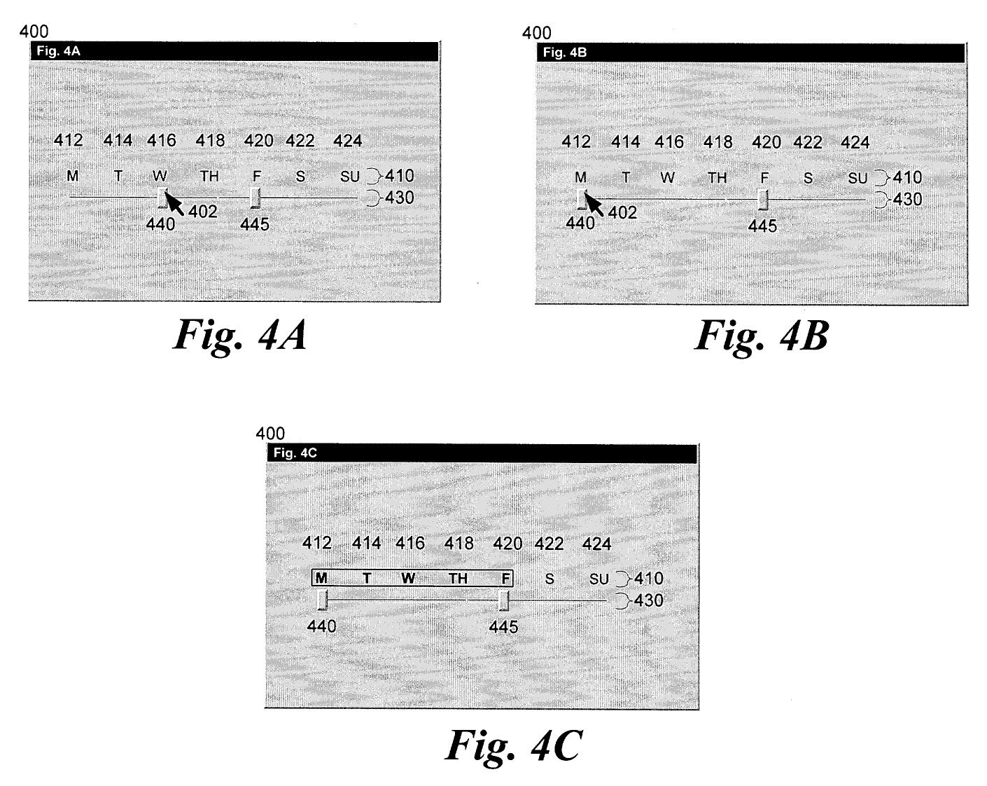

FIGS. 4A-C depict an exemplary embodiment of the present invention illustrating the aforementioned operations. In FIG. 4A, for example, a screen shot 400 depicts a plurality of objects 410 and a slide bar 430 with associated first slideable selector 440 and second slideable selector 445. The plurality of objects 410 are defined as individual textboxes 412-424. The first slideable selector 440 is related to textbox 416 and the second slideable selector 445 is related to textbox 420. A mouse pointer 402 is located over first slideable selector 440. Upon performing an operation, such as clicking a button on a mouse and dragging the mouse relative one of the plurality of objects, the first slideable selector 440 changes position relative to one of the plurality of objects. The results of this operation are shown in FIG. 4B with first selectable slider 440 located relative to textbox 412, thus, defining a range of textboxes between textbox 412 and textbox 420. In an alternative exemplary embodiment, both textboxes 412 and 420 would be included in the range. In addition, the textboxes within the range may be modified to reflect inclusion within the range. Further, in another alternative embodiment, a range may be defined by the objects outside of the slideable selectors. In this example, textboxes 412-420 would define the area outside of the range and textboxes 422 and 424 would comprise the range of objects. FIG. 4C illustrates the range of textboxes 412-420 modified to reflect inclusion within the range by bolding/highlighting the face of each textbox.

The flexibility of the present invention allows for the versatility of utilizing multiple operations. Thus, those skilled in the art will appreciate that the operations described may take on many forms and may be directed towards performing a variety of functions. For example, a slideable selector may be positioned by clicking on an object with a mouse pointer, double-clicking on an object with a mouse pointer, etc. or both slideable selectors may be positioned in the same fashion to define a range of only one object.

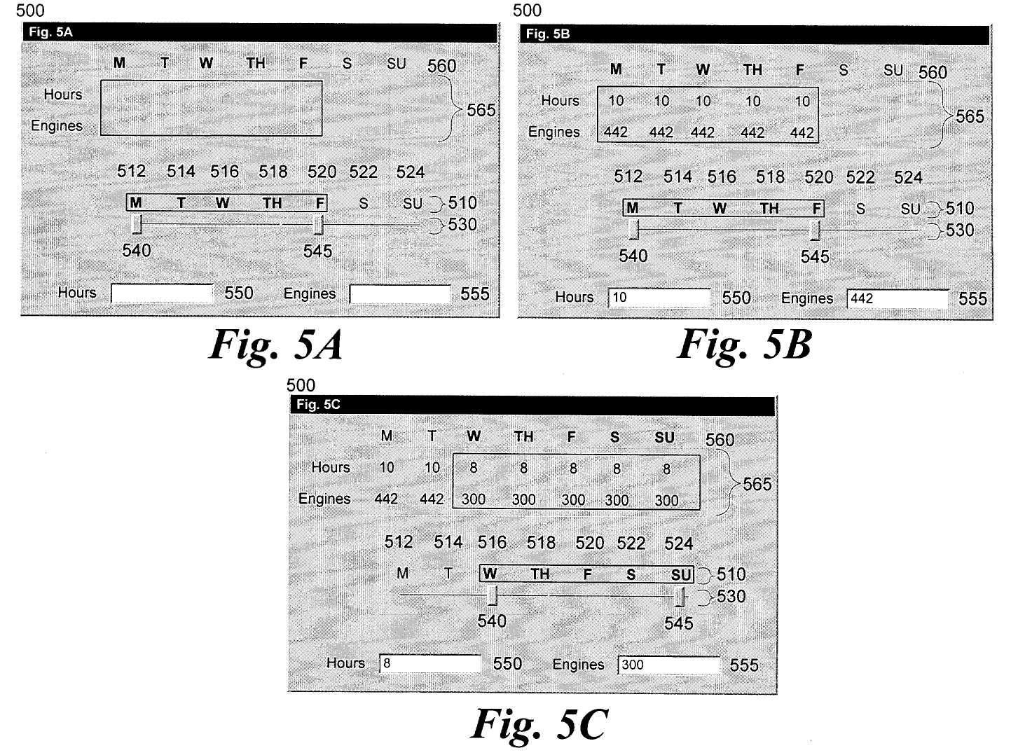

FIGS. 5A-C depict an exemplary embodiment of the present invention illustrating the aforementioned operations and rules. The association of any particular rule is only for illustrative purposes and one skilled in the art would construe it broadly and not limiting. In FIG. 5A, using the “associate an input” rule as an example, a screen shot 500 depicts a plurality of objects 510 and a slide bar 530 with associated first slideable selector 540 and second slideable selector 545. The plurality of objects 510 are defined as individual textboxes 512-524. The first slideable selector 540 is related to textbox 512 and the second slideable selector 545 is related to textbox 520. A first input area 550 is designated with associated text “Hours” and a second input area 555 is designated with associated text “Engines.” A display field 560 comprises a display area 565 and display labels comprised of the plurality of objects 510, the first input area 550 associated text “Hours” and the second input area 555 associated text “Engines.” The display area 565 remains empty until an operation is performed. A range of textboxes 512-520 is defined as described above and that area is highlighted on the display area 565. Upon entering an input into first input area 550 and second input area 555, the inputs are displayed in the display area 565 accordingly. For example, in FIG. 5B, a range of textboxes 512-520 is defined as described above, and a “10” is entered into first input area 550 and a “442” is entered into second display area 555, the display area 565 displays a “10” in row “Hours,” columns “M,” “T,” “W,” “TH,” and “F” and “442” in row “Engines,” columns “M,” “T” “W,” “TH” and “F.”

The operations and rules may be performed multiple times in a row. For example, a new range may be defined by positioning the first slideable selector 540 relative to textbox 516 and second slideable selector 545 relative to textbox 524. Changing first input area 550 to an “8” and second input area 555 to “300,” the results of this operation are shown in FIG. 5C with first selectable slider 540 located relative to textbox 516 and second slideable selector 545 located relative to textbox 524, thus, defining a range of textboxes between textbox 516 and textbox 424. The display area 565 displays an “8” in row “Hours,” columns “W,” “TH,” “F,” “S” and “SU” and “300” in row “Engines,” columns “W,” “TH,” “F,” “S” and “SU.” The display area 565 still, however, displays a “10” in row “Hours,” columns “M” and “T” and “445” in row “Engines,” columns “M” and “T.” The display area 565 of the first input area 550 and second input area 555 are the defined range of textboxes 516-524.

Another aspect of the invention is to allow the range to be defined as a single object by positioning the first and second slideable selectors in the same, or nearly the same position. In addition, once a range has been defined, the application of the range to the various objects can be adjusted by simultaneously moving both of the selectors. For instance, in an exemplary embodiment, pressing and holding a certain mouse button while dragging one of the selectors could cause both of the selectors to move in unison.

It should also be noted that although the present invention has been described with reference to the use of slideable selectors, other graphical representations could also be utilized. For instance, a simple bar could be used and the user could select various positions on the bar rather than moving slideable selectors. Other techniques could also be employed and the present invention should not be limited to any particular embodiment.

One skilled in the art will appreciate that the application of the present invention can take many forms and function and the examples provided herein are only used to illustrate a few of these possibilities. The scope of the present invention is not limited by these examples.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for defining a range associated with one or more objects, comprising the steps of:
displaying a plurality of objects;
displaying a first and a second selector, wherein said first and said second selector can be positioned relative to said plurality of objects;
positioning said first selector relative to one of said plurality of objects; and
positioning said second selector relative to one of said plurality of objects, wherein the objects located between said first and said second selector defines said range.

2. The method of claim 1, further comprising the steps of:
receiving an actuation to move said first and second selectors to be positioned relative to different objects of the plurality of objects and maintaining the said range relative to the different objects.

3. The method of claim 1, further comprising the step of:
allowing said first and second selectors to be relative to the same object, wherein said range only includes that object.

4. The method of claim 1, wherein said first selector is used to define a lower end of said range and said second selector is used to define an upper end of said range, further comprising the step of:
preventing said first selector from being positioned relative to an object that is greater than the object relative to the second selector.

5. The method of claim 1, wherein said first selector is used to define a lower end of said range and said second selector is used to define an upper end of said range, further comprising the step of:
preventing said second selector from being positioned relative to an object that is less than the object relative to the second selector.

6. The method of claim 1, wherein said first selector and said second selector are interchangeable, further comprising the step of:
allowing the first and second selectors to be positioned relative to any of the plurality of objects, wherein the first selector can be used to define either an upper end of said range or a lower end of said range.

7. The method of claim 1, wherein said first selector and said second selector are interchangeable, further comprising the step of:
allowing the first and second selectors to be positioned relative to any of the plurality of objects, wherein the second selector can be used to define either an upper end of said range or a lower end of said range.

8. A method for selecting a range of objects and applying an operation to said range, comprising the steps of:
displaying a plurality of objects;
displaying a first and a second slideable selector, wherein said first and said second slideable selector slides relative to said plurality of objects; and
positioning said first slideable selector relative to one of said plurality of objects;
positioning said second slideable selector relative to one of said plurality of objects, wherein the objects located between said first and said second slideable selector defines said range of objects; and
applying an operation to said range of objects.

9. The method of claim 8, further comprising the step of:
receiving an input to define said operation; and
displaying said range of objects and said input.

10. The method of claim 8, wherein said range is highlighted.

11. The method of claim 9, wherein the step of displaying further comprises highlighting said inputs in said range.

12. A method for selecting a range of objects and applying an operation to the range of objects, comprising the steps of:
providing a first selector that can be positioned relative to one of a plurality of objects;
providing a second selector that can be positioned relative to one of the plurality of objects;
selecting objects relative to said first selector and said second selector;
receiving an input to identify an operation to be performed on the selected objects; and
performing the operation.

13. The method of claim 12, wherein the objects are aligned and the step of selecting objects relative to said first selector and said second selector comprises:
selecting the objects between said first selector and said second selector.

14. The method of claim 12, wherein the objects are aligned and the step of selecting objects relative to said first selector and said second selector comprises:
selecting the objects between said first selector and said second selector including the objects to which said first and second selector are relatively positioned.

15. The method of claim 12, wherein the objects are functionally ordered relative to each other and the step of selecting objects relative to said first selector and said second selector comprises:
selecting the objects between said first selector and said second selector.

16. The method of claim 12, wherein the objects are functionally ordered relative to each other and the step of selecting objects relative to said first selector and said second selector comprises:
selecting the objects between said first selector and said second selector including the objects to which said first and second selector are relatively positioned.

17. The method of claim 12, wherein the step of receiving an input to identify an operation to be performed on the selected objects and performing the operation comprises the steps of:
providing a means to indicate that the input can be received;
receiving a value as input; and
applying the value to the selected objects.

18. The method of claim 12, wherein the step of receiving an input to identify an operation to be performed on the selected objects and performing the operation comprises the steps of:
providing a means to indicate that the input can be received;
receiving said input; and
applying an operation to each of the selected objects based on said input.
